(19) United States
(12) Patent Application Publication
(10) Pub. No.: US 2010/0176553 A1
(43) Pub. Date: Jul. 15, 2010

(54) Card Table, Related Devices and Methods

(76) Inventor: Gary K. Schmersal, Melbourne, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 12/352,065

(22) Filed: Jan. 12, 2009

(51) Int. Cl. A63F 11/00; F21V 33/00; A63B 71/06; A47F 7/28

(52) U.S. Cl. 273/309; 362/127; 340/323 R; 248/311.2

(57) ABSTRACT

A card table includes a table top, a plurality of indicators attached to the table top associated with respective player locations, and a control unit in signal communication with the plurality of indicators. The control unit is adapted to activate at least one of the plurality of indicators to associate a rotating player responsibility therewith and to automatically shift the at least one activated indicator based on detection of an event occurring between hands.

### FIELD OF THE INVENTION

The present invention relates to card tables, and particularly, to poker tables.

### BACKGROUND OF THE INVENTION

In many multi-player card games, such as poker, the responsibility to deal the cards (the “deal”) rotates from player to player between hands. There are generally considered to be particular advantages and/or disadvantages associated with having the deal, or being in an off-deal position. For example, the deal often determines the order in which players receive the cards and the order in which play proceeds. Accordingly, in such card games, it is considered important to carefully keep track of which player has the deal. In more informal games, this is simplified by the fact that the player having the deal physically deals the cards.

In more organized card playing venues, such as casinos and other gaming establishments, it is customary for a full-time dealer to be provided by the establishment (also called the “house”). The full-time dealer always physically deals the cards to the other players and performs other administrative functions. For example, the dealer frequently collects a portion (the “rake”) of the money wagered on each hand (the “pot”). The dealer may also serve as a banker, exchanging cash from players for corresponding tokens (“chips”).

Although the dealer always physically deals the cards, the deal still rotates through the players. Thus, to deal cards in the correct order, and for play to proceed properly, it is necessary to keep track of which player currently has the deal. Most commonly, a physical token (the “button”) is placed on the card table in front of the player having the deal.

There are several shortcomings associated with the button. For instance, since the button physically sits on the table, it can impede the smooth passing of cards from the dealer to the players. It is not uncommon for a card being dealt to hit the button such that the card's identity is inadvertently revealed to other players. Typically, this is considered a misdeal, and a re-deal is required, resulting in lost time. Also, the dealer and players must remember to shift the button between hands. Failure to do so may again in result in a misdeal, requiring a re-deal and the loss of time.

U.S. Pat. No. 1,763,476, No. 1,771,851 and No. 2,491,841 disclose card tables in which lights are selectively illuminated to indicate the player with the deal. The full-time, physical dealer is supplied with a switch or other control to shift which light is illuminated between hands. While representing an improvement over physically shifting the button, the dealer must still remember to switch lights between hands.

U.S. Patent Application Publication No. 2007/0178955 discloses an on-line poker system that allows a live poker game to be joined by players at a remote location. The status of play is constantly updated by the computer system and virtual poker tables are displayed for remote players with a “D” to indicate the dealer location. However, this system requires that the computer system must be constantly updated with game play information in order to accurately depict that status of the game, and is expensive and impractical for widespread implementation in many gaming establishments.

### SUMMARY OF THE INVENTION

In view of the foregoing, it is an object of the present invention to provide an improved card table having indicators associated with each player position. The indicators are connected to a control unit. During play, the control unit activates one of the indicators to indicate which player has the deal. The control unit automatically shifts the activated indicator when an event occurring between hands is detected.

According to an aspect of the present invention, the dealer indicator includes a light that is illuminated when activated by the control unit. According to another aspect of the present invention, the indicators have one or more alternate activation modes to indicate other responsibilities shifting between players. For example, the indicators can also indicate the location of big and small blinds. According to a further aspect of the present invention, the control unit automatically shifts the activated indicator upon detecting deposit of the rake.

Additional aspects of the present invention relate to additional devices that enhance and/or facilitate continuing play of a card game. Moreover, the present invention also includes method aspects relating to shifting the dealer indicator, and to retrofitting existing card tables with features of the present invention. These and other aspects, objects and advantages of the present invention will be better appreciated in view of the drawings and following detailed description of a preferred embodiment.

### BRIEF DESCRIPTION OF THE DRAWINGS

FIG. 1 is a schematic, perspective view of a card table, according to an embodiment of the present invention;

FIG. 2 is a schematic, perspective view of an indicator associated with the card table of FIG. 1;

FIG. 3 is a schematic, perspective view of a control unit associated with the card table of FIG. 1; and

FIG. 4 is a schematic, perspective view of a rake box associated with the card table of FIG. 1.

### DETAILED DESCRIPTION OF A PREFERRED EMBODIMENT

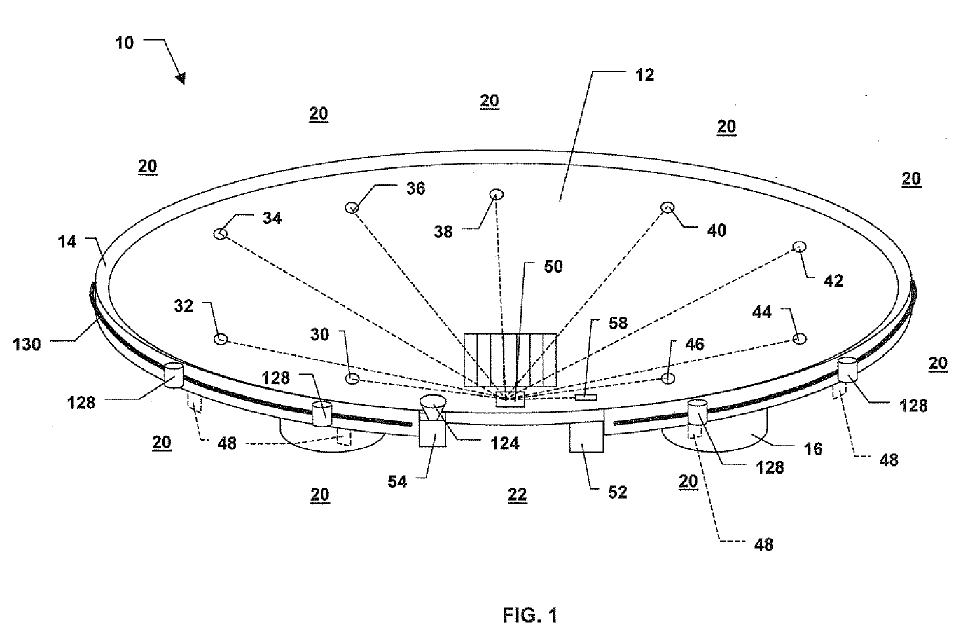

Referring to FIG. 1, according to an embodiment of the present invention, a card table 10, such as a poker table, includes a table top 12 having an outer edge 14 and supported by a base 16. For card play, a plurality of player locations 20 and a dealer location 22 are defined around the outer edge 14 of the table top 12. Chairs, stools or the like can be supplied at the player and dealer locations 20, 22 for the comfort of the players and dealers.

A plurality of indicators 30-46 are attached to the table top 12 proximate to the outer edge 14. Each indicator 30-46 corresponds to a respective one the player locations 20. Preferably, the indicators 30-46 are mounted flush with the table top 12, such the indicators 30-46 do not present a physical barrier to the smooth passage of cards across the table top 12. Optionally, the indicators 30-46 can be colored to correspond with a color of the table top 12. Additionally, a plurality of player presence sensors 48, for example, infrared temperature sensors, can be associated with respective player locations 20. Other types of sensors could be employed, for example pressure sensors or switches arranged in seats or stools at the player locations 20.

The indicators 30-46 and player presence sensors 48 are all in signal communication with a control unit 50. The control unit 50 is preferably located adjacent to, and easily accessible from, the dealer location 22. A rake box 52 and a tip box 54 are also located proximate to the dealer location 22. Preferably, a rake in insertable into the rake box 52 through a slot 58 defined in the table top 12 overlying the rake box 52. The control unit 50 is also in signal communication with the rake box 52, as will be described in greater detail, below.

At the commencement of card game play, one of the indicators 30-46, for instance, the indicator 30, is initially activated to indicate with which player location 20 the deal is currently associated. Preferably, the indicators 30-46 include lights, which are illuminated upon activation. However, the indicators 30-46 could also produce other sensible indications, such as audible indications, in lieu of, or in addition to, a visible indication. The cards are dealt and card play proceeds with the deal associated with the player location 20 corresponding to the indicator 30.

At the completion of a hand, the rake is inserted into the rake box 52. Insertion of the rake is communicated to the control unit 50. Based on this communication, the control unit 50 shifts the active indicator from the indicator 30 to the next indicator associated with an occupied player location 20, for instance, the indicator 32. This sequence repeats as necessary as card game play continues. With shifting of the active indicator occurring automatically based on detection of an event occurring between hands, such as insertion of the rake in to the rake box 52, the risk of inadvertently failing to properly track the location of the deal, and the associated loss of playing time, are minimized.

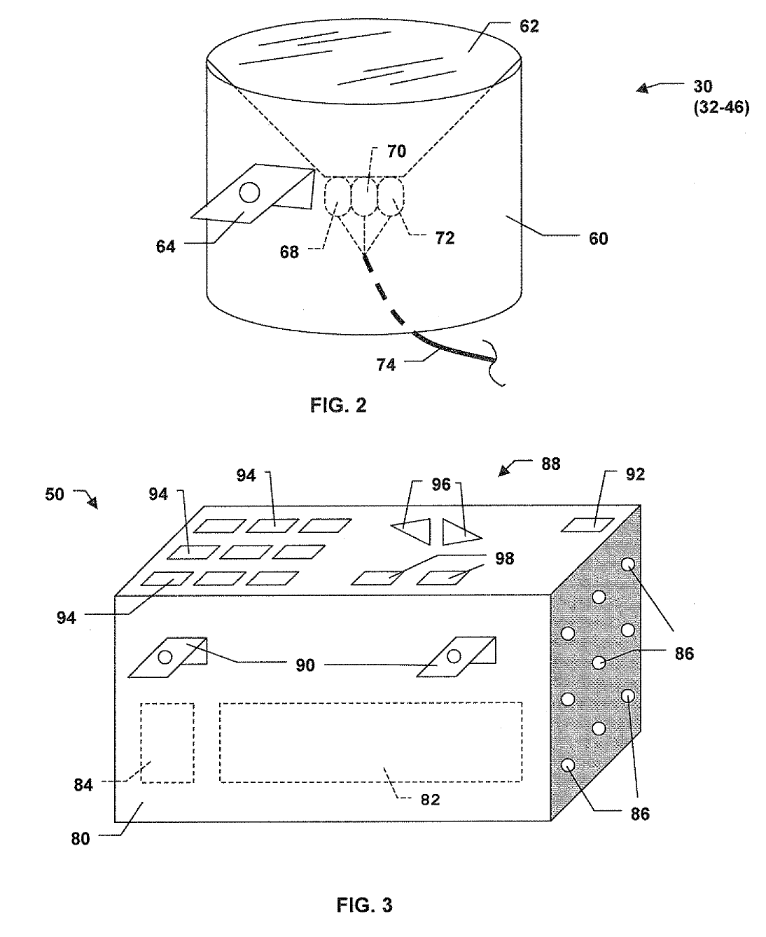

Referring to FIG. 2, an exemplary indicator 30 is illustrated. As the indicators 30-46 are substantially identical in structure, only one indicator will be described for the sake of brevity. The indicator 30 includes an indicator body 60 with a transparent or translucent cover 62, such as a lens, over an upper end thereof. At least one mounting bracket 64 is attached to the indicator body 60. The mounting bracket 64 is adapted to facilitate attachment of the indicator body 60 to the table top 12. Preferably, the mounting bracket 64 is positioned on the indicator body 60 such that the cover 62 will be flush with the table top 12 with the bracket 64 attached to an underside of the table top 12.

A plurality of lights 68-72 are located under the cover 62 and are selectively illuminatable by the control unit 50. Preferably, the lights 68-72 are connected with the control unit 50 by a cable 74, such that electrical power can be supplied therefrom and a separate power source is not required for the indicator 30. However, wireless communication with the control unit 50 could also be employed.

Additionally, it is not necessary to have a plurality of lights 68-72 to allow the indicator 30 to indicate the location of the deal when active. However, the use of more than one light enables the indicator 30 to additionally indicate the location of other rotating player responsibilities, for example, the location of big and small blinds. To facilitate the indication of different rotating responsibilities, the lights 68-72 can be of different colors or the lights 68-72 can be adapted to project different letter, numerals or symbols depending on the responsibility to be associated with the respective player location 20; for instance, a “D” to indicate the deal, an “SB” to indicate the small blind and a “BB” to indicate the big blind.

Referring to FIG. 3, the control unit 50 includes a control unit body 80 with a control circuit 82, such as a microprocessor and associated memory, and power supply 84 arranged therein. A plurality of input jacks 86 are arranged on the body 80 to allow connections between the indicators 30-46, player presence sensors 48 and rake box 52. The power supply 84 is preferably one or more batteries, such that an electrical outlet is not required in the vicinity of the card table 10. However, the control unit 50 could also be supplied with a wired power supply.

A control panel 88 is arranged on an upper surface of the body 80, and brackets 90 are attached to allow the control unit 50 to be attached to the table top 12. Preferably, the brackets 90 are adapter for securing to the underside of the table top 12 such that the upper surface will be flush with the table top 12 and the control panel 88 readily accessible proximate to the dealer location 22. The control panel 88 includes various indicators and controls, such as a power on/off indicator/button 92 to allow energizing and securing of the control unit 50 and associated equipment.

Additionally, player presence indicators/buttons 94 associated with each of the player locations 20 are also included on the control panel 88. In one mode of operation, if the player presence sensors 48 detect a player at a player location, the control unit 50 automatically illuminates a corresponding indicator/button 94. If the indication is faulty, for example, a non-player is located at a player location, the corresponding indicator/button 94 can be depressed to manually override the indication. In another mode of operation, player presence sensors 48 can be omitted and player presence can be manually input by depressing the appropriate indicators/buttons 94. The corresponding indicators 30-46 will only be activated at player locations 20 that are indicated to be occupied, whether sensed manually or automatically.

Also, manual shift buttons 96 are included on the control panel 88. The manual shift buttons 96 can be used to manually shift the active indicator when deemed necessary. For example, the buttons 96 can be used to manually shift the activated indicator 30-46 away from a player location that is incorrectly identified as occupied by a player, or if the rake is inadvertently deposited at an incorrect time.

Blind indicators/buttons 98 are further included on the control panel 88. The indicators/buttons 98 are used to indicate, and allow selection of, whether the location of one or more blinds are to be indicated by the indicators 30-46, in addition to indication of the location of the deal.

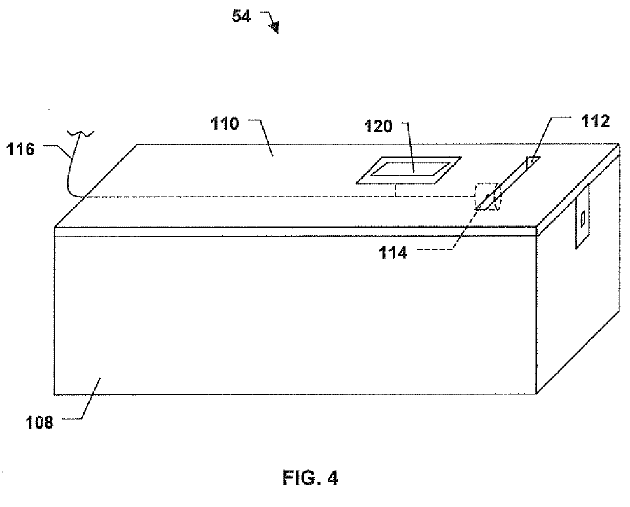

Referring to FIG. 4, the rake box 52 includes a rake box body 108 having a lockable cover 110. A slot 112 is defined in the cover 110 to allow the rake to be inserted therethrough. The rake box 52 is preferably adapted for removable installation under the table top 12, such that, with the rake box 52 installed, the slot 112 is aligned with the slot 58 in the table top 12. A rake insertion sensor 114, such as an optical sensor, is arranged proximate to the slot 112. Preferably, a cable 116 releasably connects the sensor 114 with the control unit 50 to communicate insertion of the rake.

Advantageously, the sensor 114 is also in communication with a rake counter 120. The rake counter 120 tallies the total rake inserted into the rake box 52. Where the rake is a fixed amount of each pot, for example one dollar or five dollars, the counter 120 can simply count in multiples of the fixed amount each time insertion of the rake is detected. This allows a relatively simple optical sensor 114 to employed. Alternately, a more capable sensor 114 can be used, adapted to identify the denomination of chips inserted through the slot 112. Additionally, the counter 120 can be self-driven, or controlled by the control unit 50. The counter 120 also advantageously minimizes delay by obviating the need to manually count the total when the rake box 52 is periodically removed for emptying. The total can be readily ascertained from the counter 120. The counter 120 can then be reset and the rake box 52 more quickly returned to the table 10.

Referring again to FIG. 1, the card table 10 includes additional advantageous features to enhance and/or facilitate continuing card game play. For example, the dealer tip box 54 is equipped with a funnel 124, rather than a single slot. Thus, when the dealer receives a tip of multiple chips, for instance, from a winning player, the dealer can place all the chips into the funnel 124, rather than inserting one chip at a time into the slot. Consequently, another potential source of delay is reduced or eliminated.

Additionally, a plurality of drink holders 128 are adapted to be attached outboard of the outer edge 14, rather than integrated into the table top 12. In the depicted embodiment, the drink holders 128 are connected to a rail 130 extending at least partially around the outer edge 14. While other attachment mechanisms are possible within the scope of the invention, the use of the rail 130 advantageously allows the location of drink holders 128 to be selectively positioned by players, for instance, to maximize the convenience of a left- or right-handed player. Removing drinks from the table top 12 achieves several advantages. For example, the risk of spilled drinks interrupting play is greatly reduced. Additionally, the hiding of chips behind drinks placed on the table top 12, either inadvertently or purposefully, is avoided.

The various features and aspects of the card table 10 can be originally included in the card table 10 during initial manufacture, or advantageously retrofitted into an existing card table. A retrofitting kit can include some or all of the indicators 30-46, player presence sensors 48, the control unit 50, the rake insertion sensor 114, the rake counter 120, and cables for connecting these elements with the control unit 50.

To perform the retrofit, holes are drilled through the table top adjacent player locations, the indicators 30-46 are inserted therein and secured by respective mounting brackets 64 to be flush with the table top. The player presence sensors 48 are also mounted adjacent to respective player positions. An opening is formed adjacent the dealer location for the control unit 50, which is inserted therein and secured by brackets 60. The rake box 52 is fitted with the rake insertion sensor 114 and the rake counter 120. Alternately, a replacement rake box 52 with sensor 114 and counter 120 can be supplied. The various elements are then connected with cables and the retrofit is complete. The dealer tip box 124 and drink holders 128 can also be supplied as part of the retrofit.

The above embodiment is provided for illustrative and exemplary purposes; those skilled in the art will appreciate that the present invention is not necessarily limited thereto. Numerous modifications, as well as adaptations for particular circumstances, are possible within the scope of the invention as herein shown and described, and within the scope of the appended claims.

What is claimed is:

1. A card table comprising:
a table top;
a plurality of indicators attached to the table top associated with respective player locations; and
a control unit in signal communication with the plurality of indicators;
wherein the control unit is adapted to activate at least one of the plurality of indicators to associate a rotating player responsibility therewith and to automatically shift the at least one activated indicator based on detection of an event occurring between hands.

2. The card table of claim 1, wherein the at least one activated indicator is associated with a deal location.

3. The card table of claim 2, wherein an additional one of the plurality of indicators is activated by the control unit to associate a blind location therewith.

4. The card table of claim 1, wherein the plurality of indicators include a plurality of lights selectively illuminatable by the control unit.

5. The card table of claim 1, wherein each of the plurality of indicators includes a plurality of lights separately illuminatable by the control unit.

6. The card table of claim 1 wherein the plurality of indicators include a plurality of covers mounted flush with the table top.

7. The card table of claim 1, further comprising a rake box having a rake insertion sensor in signal communication with the control unit, wherein the control unit is adapted to automatically shift the activated indicator based on detection of insertion of a rake into the rake box.

8. The card table of claim 7, wherein the rake box includes a rake counter in signal communication with the optical sensor for automatically totaling the rake inserted into the rake box.

9. The card table of claim 1, further comprising a plurality of player presence sensors associated with the respective player locations, wherein the player presence sensors are in signal communication with the control unit and the control unit is adapted to only activate indicators associated with player locations determined to be occupied.

10. The card table of claim 1, further comprising drink holders attached outboard of an outer edge of the table top.

11. The card table of claim 1, further comprising a dealer tip box having a funnel for inserting dealer tips therein.

12. A method for automatically indicating a deal location during a card game using a plurality of indicators and a control unit, the method comprising steps of:
initially activating a first one the plurality of indicators based on a signal from the control unit to associate the deal location therewith;
communicating detection of an event occurring between hands to the control unit;
automatically activating another indicator based on detection of the event; and
repeating the communicating and automatically activating steps as play of the card game continues.

13. The method of claim 12, wherein activating the indicators includes illuminating lights included in the indicators.

14. The method of claim 12, wherein the event is insertion of a rake into a rake box.

15. The method of claim 12, further comprising detecting whether player locations associated with the plurality of indicators are occupied and only activating indicators associated with occupied locations.

16. A kit for retrofitting a card game table, the kit comprising:
a plurality of indicators attachable to a table top of the table adjacent respective player locations; and
a control unit attachable to the table top and connectable in signal communication with the plurality of indicators;
wherein the control unit is adapted to activate at least one of the plurality of indicators to associate a rotating player responsibility therewith and to automatically shift the at least one activated indicator based on detection of an event occurring between hands.

17. The kit of claim 16, wherein the plurality of indicators includes a plurality of lights selectively illuminatable by the control unit.

18. The kit of claim 16, further comprising a rake insertion sensor attachable proximate to a rake box opening and connectable in signal communication with the control unit, wherein the control unit is adapted to automatically shift the activated indicator based on detection of insertion of a rake into the rake box.

19. The kit of claim 16, a plurality of player presence sensors associatable with the respective player locations and connectable in signal communication with the control unit, wherein the control unit is adapted to only activate indicators associated with player locations determined to be occupied.

20. The kit of claim 19, further comprising a plurality of drink holders adaptable for connection outboard of an outer edge of the table top.
